(19) United States
(12) Patent Application Publication
(10) Pub. No.: US 2022/0021313 A1
(43) Pub. Date: Jan. 20, 2022

(54) FUEL BATTERY SYSTEM

(71) Applicant: HONDA MOTOR CO., LTD., Tokyo (JP)

(72) Inventor: Ryota Kitamoto, Wako-shi (JP)

(21) Appl. No.: 17/368,868

(22) Filed: Jul. 7, 2021

(30) Foreign Application Priority Data
Jul. 15, 2020 (JP) 2020-121222

(51) Int. Cl. H02M 7/5387; H02M 3/155; B60L 58/40; B60L 58/30

(52) U.S. Cl. CPC H02M 7/5387; B60L 58/30; B60L 58/40; H02M 3/155

(57) ABSTRACT

A fuel battery system in which the complexity of a constitution is able to be minimized is provided. A fuel battery system includes a battery (11), a motor (13), a fuel battery stack (15), and an electric power control unit (17). The electric power control unit (17) includes a battery control unit (21) connected to the battery (11), first and second bridge circuits (23A and 23B) connected in parallel with and integrated with the battery control unit (21), and an electric power control unit (25) including the second bridge circuit (23B) and a three-phase reactor (35). The electric power control unit (25) is connected to the fuel battery stack (15) so that stepping-up control is possible.

### CROSS-REFERENCE TO RELATED APPLICATION

Priority is claimed on Japanese Patent Application No. 2020-121222, filed Jul. 15, 2020, the content of which is incorporated herein by reference.

### BACKGROUND OF THE INVENTION

### Field of the Invention

The present invention relates to a fuel battery system.

### Description of Related Art

In the related art, for example, a device including an electric power control unit formed by integrating modules such as a plurality of inverter circuits configured to control a plurality of rotary electric machines and a buck-boosting converter circuit is known (for example, refer to Patent Document 1 (Japanese Unexamined Patent Application, First Publication No. 2012-105369)).

### SUMMARY OF THE INVENTION

Incidentally, an electric power control unit including a plurality of modules which have been integrated is not limited to a device including a plurality of rotary electric machines and may be applied to a device including a combination of an electric power control unit and other devices other than a plurality of rotary electric machines and it is desired to improve the versatility and minimize the complexity of a device constitution with application to the devices described above.

An object of the present invention is to provide a fuel battery system in which the complexity of a constitution thereof can be minimized.

The fuel battery system according to the present invention has the following constitution.

(1) A fuel battery system according to an aspect of the present invention includes: at least one fuel battery stack; a power storage device; a voltage control unit connected to the power storage device; a plurality of first power conversion units connected in parallel with and integrated with the voltage control unit; and a second power conversion unit connected to the fuel battery stack and including any one of the plurality of first power conversion units and a reactor.

(2) In the fuel battery system according to the above aspect (1), the fuel battery system may include: a smoothing capacitor commonly connected in parallel with the plurality of first power conversion units, wherein each of the plurality of first power conversion units may include a plurality of switching elements which are bridge-connected, and the second power conversion unit may connect the first power conversion unit and the fuel battery stack via the reactor and is configured to perform stepping-up power conversion with respect to an input from the fuel battery stack.

(3) In the fuel battery system according to the above aspect (2), the reactor may include a multi-phase coil which is Y-connected and may be connected to the fuel battery stack at a neutral point of the multi-phase coil.

(4) In the fuel battery system according to any one of the above aspects (1) to (3), the fuel battery system may include: at least one rotary electric machine connected to any one of the plurality of first power conversion units other than the first power conversion unit constituting the second power conversion unit.

According to the aspect (1), when the second power conversion unit constituted of any one of the plurality of first power conversion units and the reactor is provided, it is possible to connect the fuel battery stack so that stepping-up control is possible. It is possible to convert electric power generated through the power generation of the fuel battery stack using a part of the plurality of first power conversion units connected in parallel with and integrated with the voltage control unit. For example, in this case, it is possible to minimize the complexity of the constitution as compared with a case in which the power conversion unit configured to convert electric power output from the fuel battery stack is additionally formed without utilizing the first power conversion unit. For example, when a part of the plurality of existing integrated first power conversion units used for controlling other devices other than the fuel battery stack is used for controlling the fuel battery stack, it is possible to improve the versatility of the plurality of integrated first power conversion units.

According to the aspect (2), when the smoothing capacitor commonly connected in parallel with the plurality of first power conversion units is provided, it is possible to eliminate the need to add another smoothing capacitor to the second power conversion unit connected to the fuel battery stack. For example, it is possible to minimize the complexity of the constitution as compared with a case in which the power conversion unit configured to convert electric power output from the fuel battery stack is newly formed without utilizing the first power conversion unit and the smoothing capacitor is provided.

(3) According to the aspect (3), for example, it is possible to use the rotary electric machine including the stator having a multi-phase wiring which is Y-connected for the reactor and it is possible to minimize the complexity of the constitution and improve the versatility of the control system of the existing rotary electric machine as compared with a case in which the reactor is newly formed.

(4) According to the aspect (4), for example, when a part of the plurality of existing integrated first power conversion units used for controlling at least one rotary electric machine is used for controlling the fuel battery stack, it is possible to improve the versatility of the plurality of integrated first power conversion units.

### BRIEF DESCRIPTION OF THE DRAWINGS

FIG. 1 is a schematic diagram showing a constitution of a fuel battery system in an embodiment of the present invention.

FIG. 2 is a diagram showing a constitution of the fuel battery system in the embodiment of the present invention.

FIG. 3 is a diagram showing a constitution of an electric power control unit of the fuel battery system in the embodiment of the present invention.

### DETAILED DESCRIPTION OF THE INVENTION

A fuel battery system 10 according to an embodiment of the present invention will be described below with reference to the accompanying drawings.

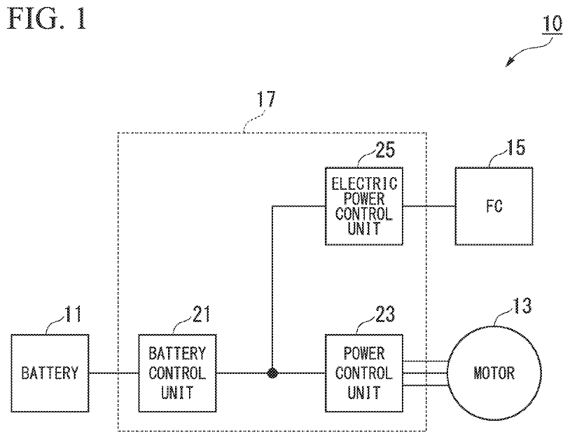

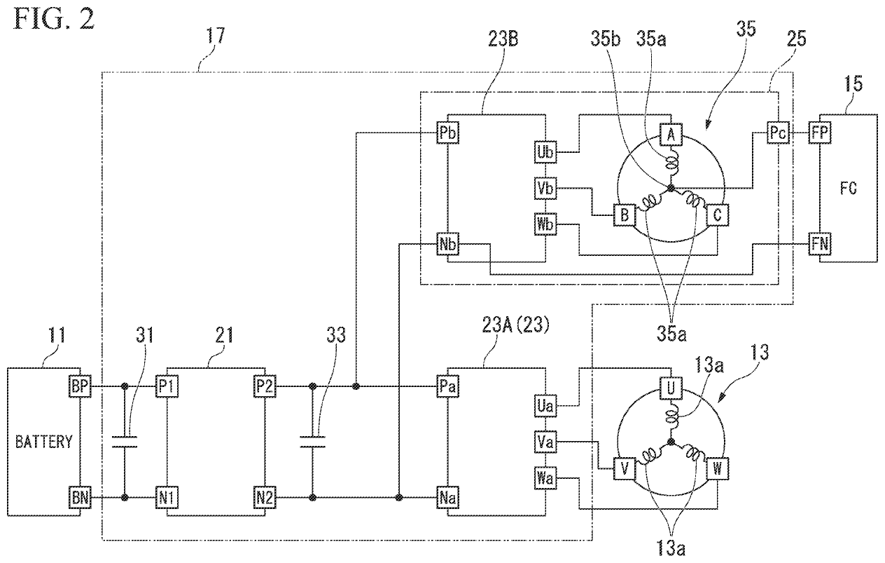

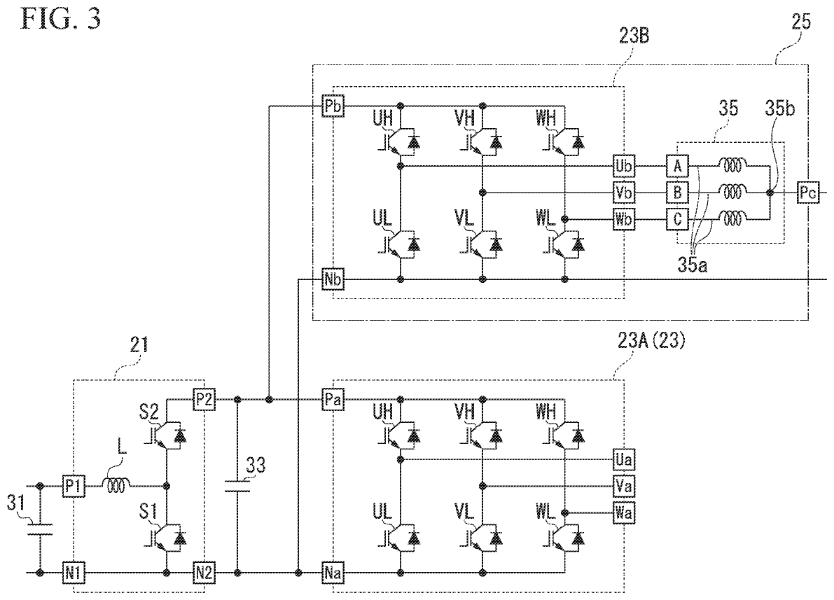

FIG. 1 is a schematic diagram showing a constitution of the fuel battery system 10 in the embodiment. FIG. 2 is a diagram showing a constitution of the fuel battery system 10 in the embodiment. FIG. 3 is a diagram showing a constitution of an electric power control unit 17 of the fuel battery system 10 in the embodiment.

The fuel battery system 10 in the embodiment is installed in, for example, a vehicle such as a fuel battery vehicle having a fuel battery used as a power source.

The fuel battery system 10 includes, for example, a battery 11, a motor 13, a fuel battery stack 15, and the electric power control unit 17.

The battery 11 is, for example, a high-voltage battery which is a power source for a vehicle. The battery 11 includes a battery case and a plurality of battery modules accommodated in the battery case. Each of the battery modules includes a plurality of battery cells connected in series. A positive electrode terminal BP and a negative electrode terminal BN of the battery 11 are connected to a battery control unit 21 of the electric power control unit 17 which will be described later.

The motor 13 is, for example, a motor configured to drive a vehicle. For example, the motor 13 is a three-phase alternating current (AC) brushless direct current (DC) motor. The three phases are a U phase, a V phase, and a W phase. The motor 13 includes a rotor having a permanent magnet for a field magnet and a stator having three-phase stator windings 13a configured to generate a rotating magnetic field which rotates the rotor. The connection of the three-phase stator windings 13a is a Y connection in which one ends of the stator windings 13a are connected at a common neutral point. The three-phase terminals U, V, and W connected to the three-phase stator windings 13a are connected to a power control unit 23 of the electric power control unit 17 which will be described later.

The motor 13 generates a rotational driving force using electric power supplied from the power control unit 23 during power running operation. The motor 13 generates generated electric power using a rotational driving force input to the rotor during regenerative operation.

The fuel battery stack (FC) 15 is, for example, a solid polymer type fuel battery. For example, the solid polymer type fuel battery includes a plurality of fuel battery cells which have been laminated and a pair of end plates having a laminate body of the plurality of fuel battery cells arranged therebetween. Each of the fuel battery cells includes an electrolyte electrode structure body and a pair of separators having the electrolyte electrode structure body arranged therebetween. The electrolyte electrode structure body includes a solid polymer electrolyte membrane and a fuel electrode and an oxygen electrode having the solid polymer electrolyte membrane arranged therebetween. The solid polymer electrolyte membrane includes a cation exchange membrane and the like. The fuel electrode (an anode) includes an anode catalyst, a gas diffusion layer, and the like. The oxygen electrode (a cathode) includes a cathode catalyst, a gas diffusion layer, and the like.

The fuel battery stack 15 generates electric power through a catalyst reaction between a fuel gas supplied from a fuel tank (not shown) to the anode and an oxidizing agent gas such as oxygen-containing air supplied from an air pump (not shown) to the cathode. A positive electrode terminal FP and a negative electrode terminal FN of the fuel battery stack 15 are connected to an electric power control unit 25 of the electric power control unit 17 which will be described later.

The electric power control unit 17 includes, for example, the battery control unit 21, the power control unit 23, the electric power control unit 25, a primary-side capacitor 31, and a smoothing capacitor 33.

The battery control unit 21 includes, for example, a DC-DC converter or the like configured to perform bidirectional power conversion of step-up and step-down. A first positive electrode terminal P1 of the battery control unit 21 is connected to the positive electrode terminal BP of the battery 11. A first negative electrode terminal N1 of the battery control unit 21 is connected to the negative electrode terminal BN of the battery 11. A second positive electrode terminal P2 of the battery control unit 21 is connected to a positive electrode terminal Pa of the power control unit 23 and a positive electrode terminal Pb of the electric power control unit 25. A second negative electrode terminal N2 of the battery control unit 21 is connected to a negative electrode terminal Na of the power control unit 23 and a negative electrode terminal Nb of the electric power control unit 25.

The first positive electrode terminal P1 and the first negative electrode terminal N1 of the battery control unit 21 are connected to the primary-side capacitor 31 in parallel with the battery 11. The second positive electrode terminal P2 and the second negative electrode terminal N2 of the battery control unit 21 are connected to the smoothing capacitor 33 in parallel with each of the power control unit 23 and the electric power control unit 25.

For example, the battery control unit 21 includes a pair of low-side arm and high-side arm switching elements and a rectifying element and a reactor. Each of the switching elements is a transistor such as an insulated gate bipolar transistor (IGBT), a metal oxide semi-conductor field effect transistor (MOSFET), or the like. The pair of low-side arm and high-side arm switching elements are a first transistor S1 of a low-side arm and a second transistor S2 of a high-side arm. The rectifying element is a freewheeling diode connected between collectors and emitters of the first transistor S1 and the second transistor S2 in a forward direction from emitters to the collectors. The reactor is a choke coil L.

The emitter of the first transistor S1 of the low-side arm is connected to the first negative electrode terminal N1 and the second negative electrode terminal N2. The collector of the second transistor S2 of the high-side arm is connected to the second positive electrode terminal P2. The collector of the first transistor S1 and the emitter of the second transistor S2 are connected to a first end of both ends of the choke coil L. A second end of both ends of the choke coil L is connected to the first positive electrode terminal P1.

The battery control unit 21 switches between turning on (allowing conduction)/turning off (cutting-off) of transistors S1 and S2 based on a gate signal which is a switching command input to gates of the transistors S1 and S2.

The battery control unit 21 steps up electric power input from the battery 11 to the first positive electrode terminal P1 and the first negative electrode terminal N1 at the time of stepping-up and outputs the stepped-up electric power from the second positive electrode terminal P2 and the second negative electrode terminal N2. The battery control unit 21 stores magnetic energy using the direct current excitation of the reactor (the choke coil) L when the second transistor S2 of the high-side arm is turned off (cut off) and the first transistor S1 of the low-side arm is turned on (conducting). The battery control unit 21 generates a voltage higher than that of the first positive electrode terminal P1 and the first negative electrode terminal N1 at the second positive electrode terminal P2 and the second negative electrode terminal N2 using an inductive voltage generated due to the magnetic energy of the reactor L and a voltage applied to the first positive electrode terminal P1 and the first negative electrode terminal N1 which overlap when the second transistor S2 of the high-side arm is turned on (conducting) and the first transistor S1 of the low-side arm is turned off (cut off).

The battery control unit 21 steps down electric power input from the second positive electrode terminal P2 and the second negative electrode terminal N2 at the time of stepping-down and outputs the stepped-down electric power from the first positive electrode terminal P1 and the first negative electrode terminal N1 to the battery 11. The battery control unit 21 stores magnetic energy using the direct current excitation of the reactor L when the second transistor S2 of the high-side arm is turned on (conducting) and the first transistor S1 of the low-side arm is turned off (cut off). The battery control unit 21 generates a voltage lower than that of the second positive electrode terminal P2 and the second negative electrode terminal N2 at the first positive electrode terminal P1 and the first negative electrode terminal N1 using the stepping-down of an inductive voltage generated due to magnetic energy of the reactor L when the second transistor S2 of the high-side arm is turned off (cut off) and the first transistor S1 of the low-side arm is turned on (conducted).

The power control unit 23 includes, for example, an inverter or the like which converts electric power between a direct current and an alternating current. The positive electrode terminal Pa of the power control unit 23 is connected to the second positive electrode terminal P2 of the battery control unit 21 and the positive electrode terminal Pb of the electric power control unit 25. The negative electrode terminal Na of the power control unit 23 is connected to the second negative electrode terminal N2 of the battery control unit 21 and the negative electrode terminal Nb of the electric power control unit 25. The three-phase terminals Ua, Va, and Wa are connected to the three-phase terminals U, V, and W of the motor 13.

For example, the power control unit 23 includes a first bridge circuit 23A formed of the plurality of switching elements and the rectifying element which are bridge-connected in three phases. The first bridge circuit 23A includes a pair of high-side arm and low-side arm U-phase transistors UH and UL, a pair of high-side arm and low-side arm V-phase transistors VH and VL, and a pair of high-side arm and low-side arm W-phase transistors WH and WL. The first bridge circuit 23A includes a freewheeling diode connected between collectors and emitters of the transistors UH, UL, VH, VL, WH, and WL in a forward direction from emitters toward the collectors.

The collectors of the transistors UH, VH, and WH of the high-side arm are connected to the positive electrode terminal Pa. The emitters of the low-side arm transistors UL, VL, and WL are connected to the negative electrode terminal Na. In each phase, the emitters of the high-side arm transistors UH, VH, and WH and the collectors of the low-side arm transistors UL, VL, and WL are connected to the phase terminals Ua, Va, and Wa.

The power control unit 23 controls, for example, the power running and regeneration of the motor 13. The power control unit 23 switches between turning on (conducting)/turning off (cutting off) of the pair of transistors of each phase based on a gate signal which is a switching command input to gates of the transistors UH, VH, WH, UL, VL, and WL.

The power control unit 23 converts DC electric power input from the positive electrode terminal Pa and the negative electrode terminal Na into three-phase AC electric power at the time of power running of the motor 13 and supplies the converted three-phase AC electric power to a motor 9. The power control unit 23 generates a rotational driving force by sequentially commutating the conduction to the three-phase stator windings 13a of the motor 13.

An electric power control unit 7 converts three-phase AC electric power input from the three-phase terminals Ua, Va, and Wa into DC electric power using turning on (conducting)/turning off (cutting off) driving of the pair of transistors of each phase synchronized with the rotation of the motor 13 at the time of regenerating of the motor 13. The electric power control unit 7 can supply the DC electric power which has been converted from the three-phase AC electric power to the battery 11 via the battery control unit 21.

The electric power control unit 25 includes, for example, a DC-DC converter or the like which performs at least stepping-up power conversion. The first positive electrode terminal Pb of the electric power control unit 25 is connected to the second positive electrode terminal P2 of the battery control unit 21 and the positive electrode terminal Pa of the power control unit 23. A second positive electrode terminal Pc of the electric power control unit 25 is connected to a positive electrode terminal FP of the fuel battery stack 15. The negative electrode terminal Nb of the electric power control unit 25 is connected to the second negative electrode terminal N2 of the battery control unit 21, the negative electrode terminal Na of the power control unit 23, and a negative electrode terminal FN of the fuel battery stack 15.

For example, the electric power control unit 25 includes the same circuit unit and reactor as in the power control unit 23. The same circuit unit as in the power control unit 23 is a second bridge circuit 23B formed of a plurality of switching elements and a rectifying element which are bridge-connected in three phases as in the first bridge circuit 23A of the power control unit 23. For example, the first bridge circuit 23A and the second bridge circuit 23B are connected in parallel with and integrated with the battery control unit 21. Here, “integration” refers to a state of being accommodated inside a common housing.

The second bridge circuit 23B includes a pair of high-side arm and low-side arm U-phase transistors UH and UL, a pair of high-side arm and low-side arm V-phase transistors VH and VL, and a pair of high-side arm and low-side arm W-phase transistors WH and WL. The second bridge circuit 23B includes a freewheeling diode connected between collectors and emitters of the transistors UH, UL, VH, VL, WH, and WL in a forward direction from emitters toward the collectors.

The collectors of the high-side arm transistors UH, VH, and WH are connected to the positive electrode terminal Pb. The emitters of the low-side arm transistors UL, VL, and WL are connected to the negative electrode terminal Nb. In each phase, the emitters of the high-side arm transistors UH, VH, and WH and the collectors of the low-side arm transistors UL, VL, and WL are connected to the phase terminals Ub, Vb, and Wb.

The electric power control unit 25 includes, for example, a three-phase reactor 35 having three-phase coils 35a with an A phase, a B phase, and a C phase as a reactor. For example, the three-phase reactor 35 may be the same as a stator having a three-phase stator winding in a three-phase AC brushless DC motor as in the motor 13.

The three-phase terminals A, B, and C of the three-phase reactor 35 are connected to the three-phase terminals Ub, Vb, and Wb of the second bridge circuit 23B. A first end of both ends of each of the three-phase coils 35a is connected to the three-phase terminals A, B, and C. A second end of both ends of each of the three-phase coils 35a is connected to a common neutral point 35b. That is to say, the connection of the three-phase coils 35a is a Y connection. The neutral point 35b is connected to the second positive electrode terminal Pc.

For example, the electric power control unit 25 steps up electric power input from the second positive electrode terminal Pc and the negative electrode terminal Nb due to the power generation of the fuel battery stack 15 and outputs the stepped-up electric power from the second positive electrode terminal Pc and the negative electrode terminal Nb. The electric power control unit 25 switches turning on (conducting)/turning off (cutting off) of the pair of transistors of each phase based on a gate signal which is a switching command input to gates of the transistors UH, VH, WH, UL, VL, and WL of the second bridge circuit 23B.

The electric power control unit 25 stores magnetic energy using the direct current excitation of the three-phase reactor 35 when the high-side arm transistors UH, VH, and WH are turned off (cut off) and the low-side arm transistors UL, VL, and WL are turned on (conducted). The electric power control unit 25 generates a voltage higher than that of the second positive electrode terminal Pc and the negative electrode terminal Nb at the first positive electrode terminal Pb and the negative electrode terminal Nb using an inductive voltage generating using the magnetic energy of the three-phase reactor 35 and a voltage applied to the second positive electrode terminal Pc and the negative electrode terminal Nb which overlap when the high-side arm transistors UH, VH, and WH are turned on (conducted) and the low-side arm transistors UL, VL, and WL are turned off (cut off).

As described above, the fuel battery system 10 in the embodiment can include the electric power control unit 25 constituted of the second bridge circuit 23B and the three-phase reactor 35 as in the first bridge circuit 23A to connect the fuel battery stack 15 so that the stepping-up control of the fuel battery stack 15 is possible. It is possible to convert electric power due to the power generation of the fuel battery stack 15 using a part of a plurality of bridge circuits (the first bridge circuit 23A and the second bridge circuit 23B) connected in parallel with and integrated with the battery control unit 21. For example, it is possible to minimize the complexity of the constitution as compared with a case in which a power conversion unit configured to convert electric power output from the fuel battery stack 15 is newly formed without utilizing the second bridge circuit 23B. For example, when a part of the plurality of existing integrated bridge circuits (the first bridge circuit 23A and the second bridge circuit 23B) used for controlling other devices other than the fuel battery stack 15 is used for controlling the fuel battery stack 15, it is possible to improve the versatility of the plurality of integrated bridge circuits (the first bridge circuit 23A and the second bridge circuit 23B).

When the smoothing capacitor 33 commonly connected in parallel with the plurality of bridge circuits (the first bridge circuit 23A and the second bridge circuit 23B) is provided, it is possible to eliminate the need to add another smoothing capacitor to the electric power control unit 25 connected to the fuel battery stack 15. For example, as compared with a case in which the power conversion unit configured to convert electric power output from the fuel battery stack 15 is newly formed without utilizing the second bridge circuit 23B and a smoothing capacitor is provided, it is possible to minimize the complexity of the constitution.

As the three-phase reactor 35 of the electric power control unit 25, for example, it is possible to use a rotary electric machine including a stator having a three-phase wiring of Y connection and it is possible to minimize the complexity of the constitution as compared with a case in which the three-phase reactor 35 is newly formed. For example, when a part of a control system including a plurality of existing integrated bridge circuits used for controlling a plurality of rotary electric machines including the motor 13 is used for controlling the fuel battery stack 15, it is possible to improve the versatility of the existing control system.

### Modified Example

A modified example of the embodiment will be described below. Constituent elements that are the same as those of the embodiment will be denoted by the same reference numerals and description thereof will be omitted or simplified.

In the above embodiment, the three-phase reactor 35 may be an attachment circuit which can be separately connected to a plurality of bridge circuits (a first bridge circuit 23A and a second bridge circuit 23B) connected in parallel with and integrated with a battery control unit 21.

Although an electric power control unit 25 performs power conversion for stepping up a voltage in the above embodiment, the present invention is not limited thereto. For example, when electric power is supplied to a device connected to the fuel battery stack 15, the electric power control unit 25 may perform bidirectional power conversion of stepping-up and stepping-down. The device connected to the fuel battery stack 15 may be, for example, an air pump or the like configured to supply air as an oxidizing agent gas to the fuel battery stack 15. The electric power control unit 25 may step down electric power input from a positive electrode terminal Pb and a negative electrode terminal Nb, for example, at the time of starting of power generation of the fuel battery stack 15, to supply electric power required for driving an air pump.

The electric power control unit 25 steps down electric power input from a first positive electrode terminal Pb and a negative electrode terminal Nb at the time of stepping-down and outputs the stepped-down electric power from a second positive electrode terminal Pc and a negative electrode terminal Nb. The electric power control unit 25 stores magnetic energy using direct current excitation of a three-phase reactor 35 when high-side arm transistors UH, VH, and WH of a second bridge circuit 23B are turned on (conducted) and low-side arm transistors UL, VL, and WL thereof are turned off (cut off). The electric power control unit 25 generates a voltage lower than that of the first positive electrode terminal Pb and the negative electrode terminal Nb at the second positive electrode terminal Pc and the negative electrode terminal Nb using the stepping-down of an inductive voltage generated using magnetic energy of the three-phase reactor 35 when the high-side arm transistors UH, VH, and WH are turned off (cut off) and the low-side arm transistors UL, VL, and WL are turned on (conducted).

Although a fuel battery system 10 includes one motor 13 and one fuel battery stack 15 in the above embodiment, the present invention is not limited thereto, and the fuel battery system 10 may include a plurality of motors 13 or may include a plurality of fuel battery stacks 15. The fuel battery system 10 may include a plurality of bridge circuits having the same constitution as the first bridge circuit 23A and the second bridge circuit 23B connected in parallel with and integrated with a battery control unit 21 to correspond to the plurality of the motor 13 and the fuel battery stack 15. In this case, each of a plurality of electric power control units 25 connected to a plurality of fuel battery stacks 15 includes any one of a plurality of bridge circuits and a reactor.

Although an example in which the fuel battery system is installed in a fuel battery vehicle in which electric power generated in a fuel battery is used as electric power for traveling or electric power for operating an in-vehicle device has been described in the above embodiment, the system may be installed in automobiles such as two-wheeled, three-wheeled, four-wheeled vehicles and other mobile objects (for example, ships, flying objects, and robots) and may be installed in stationary or portable fuel battery systems.

The embodiments of the present invention are presented as examples and are not intended to limit the scope of the present invention. These embodiments can be implemented in various other forms and various omissions, replacements, and changes are possible without departing from the gist of the present invention. These embodiments and modifications thereof are included in the scope and the gist of the present invention described in the claims and the equivalent scope thereof.

### EXPLANATION OF REFERENCES

10 Fuel battery system
11 Battery (power storage device)
13 Motor (rotary electric machine)
15 Fuel battery stack
17 Electric power control unit
21 Battery control unit (voltage control unit)
23 Power control unit
23A First bridge circuit (first power conversion unit)
23B Second bridge circuit (first power conversion unit)
25 Electric power control unit (second power conversion unit)
31 Primary-side capacitor
33 Smoothing capacitor
35 Three-phase reactor (reactor)
UH, UL High-side arm and low-side arm U-phase transistor (switching element)
VH, VL High-side arm and low-side arm V-phase transistor (switching element)
WH, WL High-side arm and low-side arm W-phase transistor (switching element)

What is claimed is:

1. A fuel battery system comprising:
at least one fuel battery stack;
a power storage device;
a voltage control unit connected to the power storage device;
a plurality of first power conversion units connected in parallel with and integrated with the voltage control unit; and
a second power conversion unit connected to the fuel battery stack and including any one of the plurality of first power conversion units and a reactor.

2. The fuel battery system according to claim 1, comprising:
a smoothing capacitor commonly connected in parallel with the plurality of first power conversion units,
wherein each of the plurality of first power conversion units includes a plurality of switching elements which are bridge-connected, and
the second power conversion unit connects the first power conversion unit and the fuel battery stack via the reactor and is configured to perform stepping-up power conversion with respect to an input from the fuel battery stack.

3. The fuel battery system according to claim 2, wherein the reactor includes a multi-phase coil which is Y-connected and is connected to the fuel battery stack at a neutral point of the multi-phase coil.

4. The fuel battery system according to any one of claim 1, comprising:
at least one rotary electric machine connected to any one of the plurality of first power conversion units other than the first power conversion unit constituting the second power conversion unit.

5. The fuel battery system according to any one of claim 2, comprising:
at least one rotary electric machine connected to any one of the plurality of first power conversion units other than the first power conversion unit constituting the second power conversion unit.

6. The fuel battery system according to any one of claim 3, comprising:
at least one rotary electric machine connected to any one of the plurality of first power conversion units other than the first power conversion unit constituting the second power conversion unit.
